(19) United States
(12) Patent Application Publication
(10) Pub. No.: US 2005/0144132 A1
(43) Pub. Date: Jun. 30, 2005

(54) Digital anti-counterfeit authentication method

(76) Inventor: Ching-Wen Lin, Taipei (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/022,617

(22) Filed: Dec. 27, 2004

(30) Foreign Application Priority Data
Dec. 31, 2003 (TW) 092137784

(51) Int. Cl. H04K 1/00; H04L 9/00; G06F 17/60; G06K 9/00; G06F 17/00

(52) U.S. Cl. 705/50; 235/375

(57) ABSTRACT

A digital anti-counterfeit authentication method uses an one-time destructive anti-counterfeit label and a closed loop information feedback and control system. The invention covers the basic activities of an enterprise. The method includes: (1) fabricating anti-counterfeit data according to one or more product; (2) one or more consumer entering the anti-counterfeit data through one or more input end and interface end; (3) a server end starting inspection of the anti-counterfeit data, and entering step (4) when the inspection passes, and entering step (5) when the inspection fails to pass; (4) providing authentication results to the consumer and the manufacturer that supplied the one or more product, and going to step (6); (5) providing authentication results to the consumer and the manufacturer, and observing whether the consumer continuously use the same product, if yes, go to step (2), otherwise go to step (6); (6) ending the process. The step (3) includes multiple modes of authentication to protect consumer's safety and benefits.

### FIELD OF THE INVENTION

The present invention relates to a digital anti-counterfeit authentication method that uses multiple modes of authentication approaches to protect consumer's safety and benefits and enables manufacturers to do instant product recording and tracking.

### BACKGROUND OF THE INVENTION

Nowadays almost all types of enterprises and brands have to compete internationally in terms of capital, technology, marketing strategy and business model. How to help the enterprises to become bigger and stronger and help the enterprises to establish a long standing brand is an important issue. In this perspective, the anti-counterfeit concept and technology are gradually being recognized and accepted.

Anti-counterfeit concept is evolved rapidly. It is initially pushed by a few large enterprises and well known brands. With the market becoming ever more competitive and after joining the WTO, most enterprises these days not only care about counterfeit prevention, they also have to build brands and use advanced technology to increase market share and competitiveness.

These days the techniques of counterfeit or fake have become very sophisticated. For instance, burners are widely used to copy proprietary products in the computer industry, and fake bottle caps are made to sell bogus wine. This creates a great impact to the sales and market share of the legitimate manufacturers or established brands. If the fake product only copies the exterior of hardware or software content, it does not have much harmful effect to human health, and may be considered a lower mode counterfeit. However, if the fake product is foodstuff and could be harmful to human body or even fatal to human life once consumed, it becomes a criminal behavior and must be subject to moral and legal punishment.

While the fake foodstuff could harm the health of consumers and should be prosecuted strictly, faking well known products that results in shrinking of sales of the genuine products could also cause slash of employee's salary, layoff, plant closing or even bankruptcy. Its impact is huge. In severe situations, the economy of the affected area in a country could be dragged downwards, and people's livelihood suffers.

In recent years, intellectual property right has gained a lot of awareness. Still, software of Microsoft Co. has been copied constantly, author's copy right has been infringed. There are many people trying to benefit from other people's efforts without paying proper compensation. This produces a negative impact to people's risk taking spirit and research efforts. It also affects future advancement of mankind.

In view of the aforesaid conditions, it is clear that faking and counterfeiting techniques have become very sophisticated. The present invention aims to develop an anti-counterfeit authentication method to address this issue.

### SUMMARY OF THE INVENTION

Therefore the first object of the invention is to provide a digital anti-counterfeit authentication method that has multiple modes of authentication means to inspect product authenticity and identify faked products, and check whether a product has been unpacked, thereby to protect the safety and benefits of consumers.

A second object of the invention is to provide a digital anti-counterfeit authentication method that enables manufacturers to track products in the event that questionable products are found.

A third object of the invention is to provide a digital anti-counterfeit authentication method to prevent consumers from eating faked foodstuff and resulting in health hazard or even loss of live, and to reduce unnecessary social costs.

A fourth object of the invention is to provide a digital anti-counterfeit authentication method to prevent physical products or software from being unlawfully copied and reproduced and enables consumers to maintain correct procurement concept and keeps proper sales channels to function smoothly.

A fifth object of the invention is to provide a digital anti-counterfeit authentication method to prevent people from fostering free-lunch concept and encourage people to devote in research and development to achieve more advancements for mankind.

The digital anti-counterfeit authentication method according to the invention is a closed loop information feedback and control method. It covers the basic enterprise activities. The method includes: (1) fabricating anti-counterfeit data according to one or more product; (2) one or more consumer entering the anti-counterfeit data through one or more input end and interface end; (3) a server end starting inspection of the anti-counterfeit data, and entering step (4) when the inspection passes, and entering step (5) when the inspection fails to pass; (4) providing authentication results to the consumers and the manufacturer that supplied the one or more product, and going to step (6); (5) providing authentication results to the consumers and the manufacturer, and observing whether the consumer continuously use same kind of product, if yes, go to step (2), if no, go to step (6); (6) ending the process. The step (3) includes multiple modes of authentication to protect consumer's safety and benefits.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of the system architecture of the invention.

FIG. 2 is a flow chart of the method of the invention.

### DESCRIPTION OF THE PREFERRED EMBODIMENT

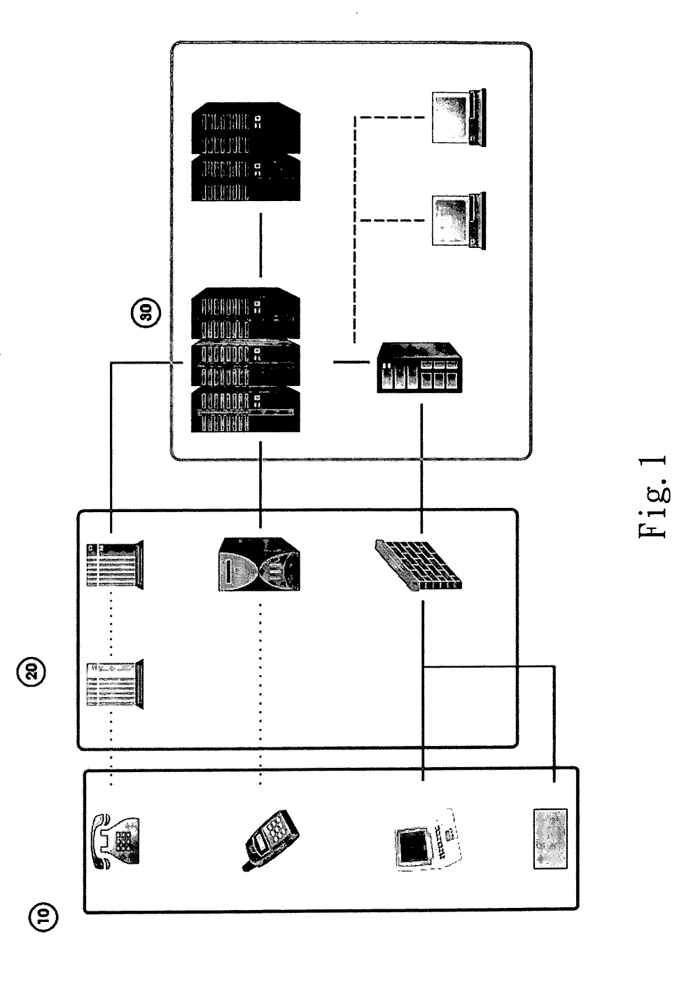

Refer to FIG. 1 for the system architecture of the invention. A consumer enters an anti-counterfeit data of a product, such as an anti-counterfeit code, from an input end 10 to a server end 30 through an interface end 20. The input end 10 may be one of the following systems: telephone voice system, mobile communication short message service, network system, and other communication interface systems. The interface end 20 may be one of the following systems: telephone switch system, automatic voice system, short message display system, and fire-wall system. The server end 30 includes: a database system, backup system, administration system, technical system and network access system. After the process of anti-counterfeit authentication has finished, a feedback is sent from the server end 30 through the interface end 20 to the input end 10 to inform the authentication results to the consumer and the manufacturer.

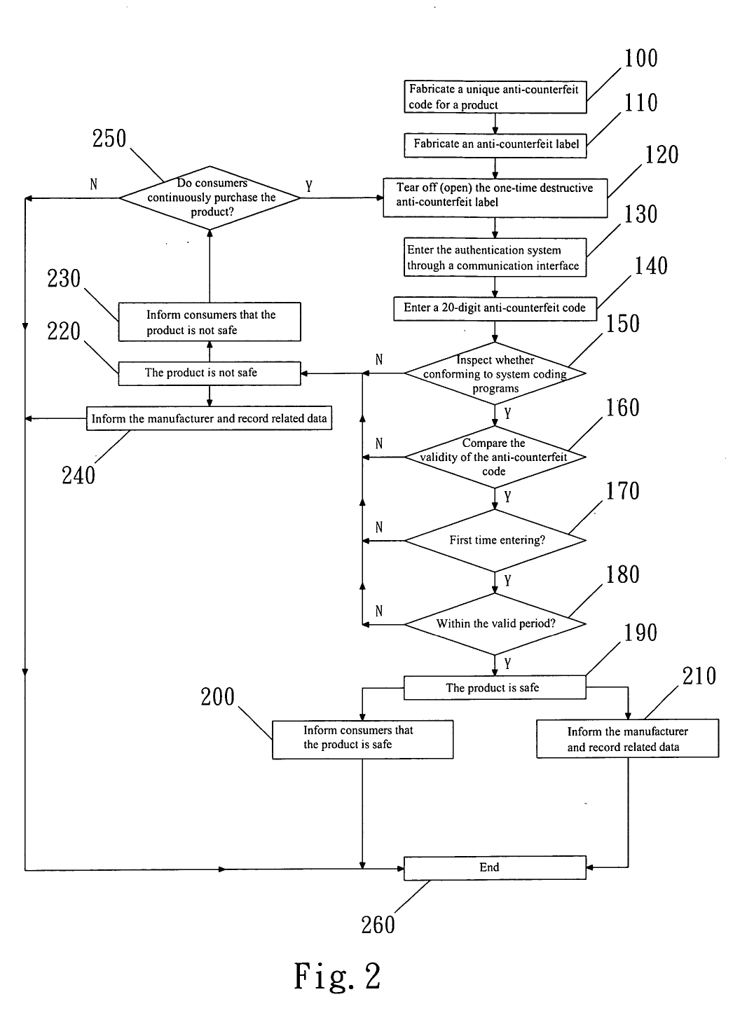

The invention employs an one-time destructive anti-counterfeit label and a closed loop information feedback and control method. The closed loop information feedback and control method covers the enterprise basic activities such as production, distribution, sales, promotion, market research, customer feedback, counterfeit prevention, electronic business, and the like. The closed loop information feedback and control method includes an authentication process which is shown in FIG. 2. Details are as follow:
Step 100: Generate a unique anti-counterfeit data content of a product, including an anti-counterfeit code of twenty digits and related product data such as enterprise name, product code, product name, serial number, batch number, production date, sales territory, distributor code, and the like. After data entry is finished, enter the nest step;
Step 110: Fabricate an anti-counterfeit label which is a dedicated authentication data of the product; enter the next step;
Step 120: After a consumer has purchased the product, he/she tears off (or scrapes) the one-time destructive anti-counterfeit destructive label which is not safe once used. Hence the anti-counterfeit label may be inspected during purchasing to ensure that the product is proper and safe. If no problem is found in the inspection, enter the next step;
Step 130: The consumer accesses the authentication system in the server end 30 from the input end 20 through the interface end 20; enter the next step;
Step 140: Enter the anti-counterfeit data of the product. The anti-counterfeit data is like an ID and is unique to the product. After finishing data entry, go to the next step;
Step 150: Verify whether conforming to the system coding program. If yes, go to the next step; otherwise, go to step 220;
Step 160: Compare and check the validity of the content of the anti-counterfeit data, if correct, go to the next step; otherwise, go the step 220;
Step 170: Confirm whether it is the first time entry; if yes, go to the next step and the product is proved genuine; otherwise, go to step 220:
Step 180: Inspect whether the product is within the valid period to protect the safety of consumers; if yes, go to the nest step; otherwise, go to step 220;
Step 190: The product is safe. After the multiple modes of inspections previously discussed, it is confirmed that the product is genuine and may be consumed safely. Then go to the following two steps;
Step 200: Feedback to the consumer that the product is safe, then go to step 260;
Step 210: Feedback to the manufacturer and record related data, and go to step 260;
Step 220: The product is not safe. If the product fails to pass any of the inspections set forth above, it is deemed a questionable product, enter the next two steps;
Step 230: Feedback to the consumer that the product is not safe, and go to step 250;
Step 240: Feedback to the manufacturer and record and track the related data, go to step 260;
Step 250: Track by a feedback means whether the consumer continuously purchase the product, if yes, return to step 120; otherwise, go to step 260;
Step 260: End of the process.

Now a practical example done by a consumer is discussed as follow to further explain the invention: a consumer buys a bottle of wine; the bottle is stuck with an anti-counterfeit label which has a processed anti-counterfeit code covered by the anti-counterfeit label; during purchasing, the consumer can inspect if the anti-counterfeit label has a torn trace as the first step to determine whether to buy the wine; after purchased, the consumer tears off the anti-counterfeit label to get the anti-counterfeit code; then the consumer can enter the anti-counterfeit data on the input end 10 to send the data to the server end 30 through the interface end 20, and the server end 30 checks the anti-counterfeit data to verify the genuineness and safety of the product. After this multiple authentication, the credibility and safety of the product is enhanced. The result is sent in a feedback manner from the server end 30 to the input end 10 through the interface end 20, so that the consumer and the manufacturer are informed of the result of authentication.

By means of the digital anti-counterfeit authentication method of the invention, multiple modes of authentication are performed to enhance the credibility and safety of products to consumers. For the fake products or expired foodstuffs, the manufacturer can further track and investigate. Thus it provides huge benefits to consumers and manufacturers.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

1. A digital anti-counterfeit authentication method using a closed loop information feedback and control system to cover basic activities of an enterprise, comprising the steps of:
(1) fabricating anti-counterfeit data of one or more product;
(2) entering the anti-counterfeit data by one or more consumer on one or more input end and interface end;
(3) inspecting the anti-counterfeit data by a server end for authentication, going to step (4) for those succeeded in the authentication, and going to step (5) for those failed in the authentication;
(4) providing authentication results of the one or more product to the consumer, and going to step (6);
(5) providing the authentication results to the consumer and manufacturers, and observing whether the consumer continuously purchases the product, if yes go to step (2), otherwise go to step (6);
(6) Ending process.

2. The method of claim 1, wherein the basic activities of an enterprise include production, distribution, promotion, market research, customer feedback, counterfeit prevention, and electronic business.

3. The method of claim 1, wherein the step (1) further includes:
(1a) generating a unique anti-counterfeit data content corresponding to the product including an anti-counterfeit code; and
(1b) fabricating an anti-counterfeit label which contains the anti-counterfeit code.

4. The method of claim 1, wherein the input end is selected from the group consisting of a telephone voice system, a mobile communication short message system, a network system, and selected communication interface systems.

5. The method of claim 3, wherein the interface end is a combination of a telephone switch system, an automatic voice system, a short message display system and a fire-wall system.

6. The method of claim 1, wherein the step (2) further includes:
(2a) destroying the one-time destructive anti-counterfeit data;
(2b) entering an authentication system through the input end and the interface end; and
(1c) entering the content of the anti-counterfeit data of the product including an anti-counterfeit code.

7. The method of claim 1, wherein the server end includes a database system, a backup system, an administration system, a technical system, and a network access system.

8. The method of claim 1, wherein the step (3) further includes:
(3a) inspecting whether conforming to a system coding program, and go to the next step if yes, otherwise go to step (5);
(3b) comparing the validity of the content of the anti-counterfeit data including an anti-counterfeit code, go to the next step if valid, otherwise go to step (5);
(3c) confirming whether the input is the first time, go to the next step if yes, otherwise go to step (5); and
(3d) confirming whether the product is within a valid period, go to the next step if yes, otherwise go to step (5).

9. The method of claim 1, wherein the step (5) further provides manufacturer tracking data.
